(19) United States
(12) Patent Application Publication
(10) Pub. No.: US 2010/0076978 A1
(43) Pub. Date: Mar. 25, 2010

(54) SUMMARIZING ONLINE FORUMS INTO QUESTION-CONTEXT-ANSWER TRIPLES

(75) Inventors: Gao Cong, Aalborg (DK); Chin-Yew Lin, Beijing (CN); Shilin Ding, Madison, WI (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/207,231

(22) Filed: Sep. 9, 2008

(51) Int. Cl. G06F 7/00; G06F 17/30

(52) U.S. Cl. 707/738; 707/E17.069

(57) ABSTRACT

In this paper, we propose a new approach to extracting question-context-answer triples from online discussion forums. More specifically, we propose a general framework based on Conditional Random Fields (CRFs) for context and answer detection, and also extend the basic framework to utilize contexts for answer detection and to better accommodate the features of forums.

### BACKGROUND

Forums are virtual Web spaces where people can ask questions, answer questions and participate in discussions. The availability of affluent thread discussions in forums has promoted increasing interests in knowledge acquisition and summarization for forum threads. A forum thread usually consists of an initiating post and a number of reply posts. The initiating post usually contains several questions and the reply posts usually contain answers to the questions and perhaps new questions. Forum participants are not physically co-present, and thus reply may not happen immediately after questions are posted. The asynchronous nature and multi-participants make multiple questions and answers interweaved together, which makes it more difficult to summarize.

### SUMMARY

The present invention addresses the above-stated problems by providing software mechanisms for detecting question-context-answer triples from forums.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example thread with annotated question-context-answer text.

FIG. 2A illustrates example Linear CRF models used in accordance with aspects of the present invention.

FIG. 2B illustrates example Skip Chain CRF models used in accordance with aspects of the present invention.

FIG. 2C illustrates example 2D CRF models used in accordance with aspects of the present invention.

FIG. 3 illustrates features for linear CRFs.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “evaluator,” “sensor,” “device,” “cloud,” “network,” “optimizer,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

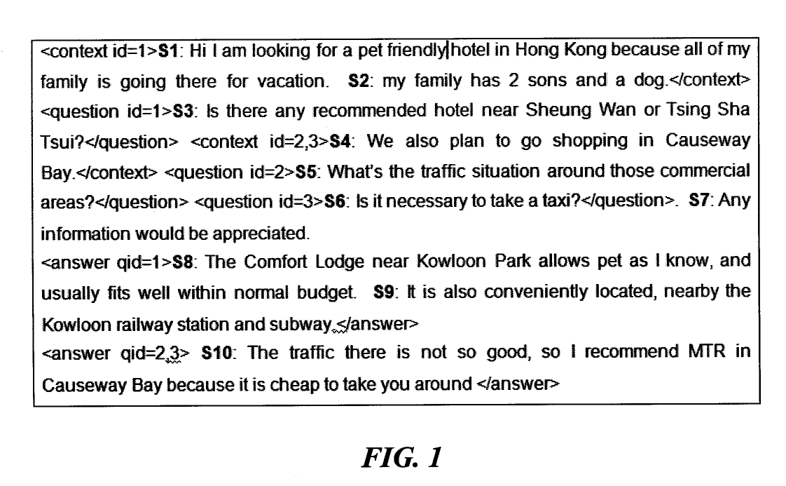

Referring now to FIG. 1, aspects of the software mechanisms for detecting question-context-answer triples is explained. FIG. 1 illustrates an example of a forum thread with questions, contexts and answers annotated. It contains three question sentences, S3, S5 and S6. Sentences S1 and S2 are contexts of question 1 (S3). Sentence S4 is the context of questions 2 and 3, but not 1. Sentence S8 is the answer to question 3. One ex-ample of question-context-answer triple is (S4-S5-S10). As shown in the example, a forum question usually requires contextual information to provide background or constraints. In addition, it may be beneficial to provide contextual information to provide explicit link to its answers. For example, S8 is an answer of question 1, but they cannot be linked with any common word. Instead, S8 shares word pet with S1, which is a context of question 1, and thus S8 could be linked with question 1 through S1. For illustrative purpose, contextual information is referred to as the context of a question.

A summary of forum threads in the form of question-context-answer can not only highlight the main content, but also provide a user-friendly organization of threads, which will make the access to forum information easier.

Another motivation of detecting question-context-answer triples in forum threads is that it could be used to enrich the knowledge base of community-based question and answering (CQA) services such as Live QnA and Yahoo! Answers, where context is comparable with the question description while question corresponds to the question title. For example, there were about 700,000 questions in the Yahoo! Answers travel category as of January 2008. This, for example, was based on using approximately 3,000,000 travel related questions from six online travel forums. One would expect that a CQA service with large QA data will attract more users to the service.

It is challenging to summarize forum threads into question-context-answer triples. First, detecting contexts of a question is challenging and non-trivial. Data in one example background study indicated that 74% of questions in a corpus containing 2,041 questions from 591 forum threads about travel need context. However, relative position information is far from adequate to solve the problem. For example, in a corpus 37% of sentences preceding questions are contexts and they only represent 20% of all correct contexts. To effectively detect contexts, the dependency between sentences is important. For example in FIG. 1, both S1 and S2 are contexts of question 1. S1 could be labeled as context based on word similarity, but it is not easy to link S2 with the question directly. S1 and S2 are linked by the common word family, and thus S2 can be linked with question 1 through S1. The challenge here is how to model and utilize the dependency for context detection.

Second, it is difficult to link answers with questions. In forums, multiple questions and answers can be discussed in parallel and are interweaved together while the reply relationship between posts is usually unavailable. To detect answers, we need to handle two kinds of dependencies. One is the dependency relationship between contexts and answers, which should be leveraged especially when questions alone do not provide sufficient information to find answers; the other is the dependency between answer candidates (similar to sentence dependency described above). The challenge is how to model and utilize these two kinds of dependencies.

The present invention provides a novel approach for summarizing forum threads into question-context-answer triples. In one aspect of the invention, it provides mechanisms for extracting question-context-answer triples from forum threads. In summary, the invention utilizes a classification method to identify questions from forum data as focuses of a thread, and then employ Linear Conditional Random Fields (CRFs) to identify contexts and answers, which can capture the relationships between contiguous sentences. The present invention also captures the dependency between contexts and answers, which introduces a skip-chain CRF model for answer detection. The present invention also extends the basic model to 2D CRF's to model dependency between contiguous questions in a forum thread for context and answer identification. Also described herein, data showing actual implementations of the invention using forum data is illustrated and explained below.

The following section first introduces the problem of finding question-context-answer triples from forums, and then describes the solutions presented by the invention. For illustrative purposes, an introduction problem statement is proposed as: a question is a linguistic expression used by a questioner to request information in the form of an answer. A question usually contains question focus, i.e., question concept that embodies information expectation of question and constraints. The sentence containing question focus is called question anchor or simply question and the sentences containing only constraints are called context. Context provides constraint or background information to question.

The challenge of processing question-context-answer triples from forums is approached by first identifying questions in a thread, and then identifying the context and answer of every question within a uniform framework. The following section first briefly presents an approach to question detection, and then focus on context and answer detection.

For question detection in forums, rules, such as question mark and 5W1H words, are not adequate. With question mark as an example, we find that 30% questions do not end with question marks while 9% sentences ending with question marks are not questions in a corpus. To complement the inadequacy of simple rules, the present invention builds a SVM classifier to detect questions. For the next steps, given a thread and a set of m detected questions {Qᵢ}ᵢ₌₁^{m}, one task is to find the contexts and answers for each question. The section below first describes an embodiment using linear CRFs model for context and answer detection, and then extends the basic framework to Skip-chain CRFs and 2D CRFs to better model the problem. Finally, this description will introduce CRF models and the related features.

For ease of presentation, the following first discusses detecting contexts of the questions using linear CRF model. The model could be easily extended to answer detection.

As discussed above, context detection cannot be trivially solved by position information, and dependency between sentences is important for context detection. Referring again to FIG. 1, S2 could be labeled as context of Q1 if the process considers the dependency between S2 and S1, and that between S1 and Q1, while it is difficult to establish connection between S2 and Q1 without S1. Table 1 shows that the correlation between the labels of contiguous sentences is significant. In other words, when a sentence Yₜ's previous Yₜ₋₁ is not a context (Yₜ₋₁≠C) then it is very likely that Yₜ (i.e. Yₜ≠C) is also not a context. It is clear that the candidate contexts are not independent and there are strong dependency relationships between contiguous sentences in a forum. Therefore, a desirable model should be able to capture the dependency.

TABLE 1
Contingency table (x² = 13,044, p-value <0.001)

| Contiguous sentences | yₜ = C | yₜ ≠ C |
|---|---|---|
| yₜ₋₁ = C | 1,191 | 1,366 |
| yₜ₋₁ ≠ C | 1,377 | 62,446 |

The context detection can be modeled as a classification problem. Traditional classification tools, e.g. SVM, can be employed, where each pair of question and candidate context will be treated as an instance. However, they cannot capture the dependency relationship between sentences.

To this end, we proposed a general framework to detect contexts and answers based on Conditional Random Fields (CRF's) which are able to model the sequential dependencies between contiguous nodes. A CRF is an undirected graphical model G of the conditional distribution P (Y|X). X is the random variables over the labels of the nodes that are globally conditioned on X, which are the random variables of the observations.

Linear CRF model has been successfully applied in NLP and text mining tasks. However, the current problem cannot be modeled with Linear CRFs in the same way as other NLP tasks, where one node has a unique label. In the current problem, each node (sentence) might have multiple labels since (1) one sentence could be the context of multiple questions in a thread or (2) it could be the context of one question but not the other. Thus, it is difficult to find a solution such that we can tag context sentences for all questions in a thread in single pass.

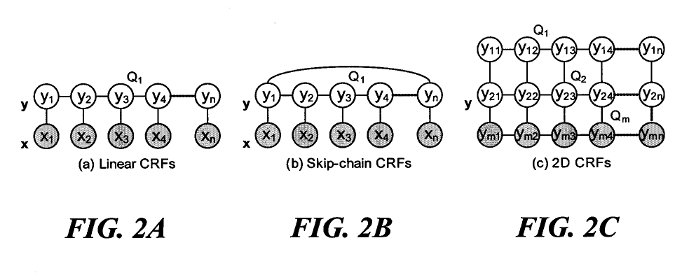

Here we assume that questions in a given thread are independent and are found, and then we can label a thread with m questions one-by-one in m—passes. In each pass, one question Qᵢ is selected as focus and each other sentence in the thread will be labeled as context C of Qᵢ or not using Linear CRF model. The graphical representations of Linear CRFs is shown in FIG. 2A. The linear-chain edges can capture the dependency between two contiguous nodes. The observation sequence x=<x₁, x₂, . . . , xₜ>, where t is the number of sentences in a thread, represents predictors (to be described in Section 3.2.5), and the tag sequence y=<y₁, . . . , yₜ>, where yᵢε{C,P}, determines whether a sentence is plain text P or context C of question Qᵢ.

The following section describes aspects of answer detection. Answers usually appear in the posts after the post containing the question. It is assumed that a paragraph is usually a good segment for answer while the proposed approach is applicable to other kinds of segments. There are also strong dependencies between contiguous answer segments. Thus, position information and similarity method are not adequate for answer detection. To cope with the dependency between contiguous answer segments, we employ linear CRF models for answer detection.

In an example test, it was observed that 74% questions lack contextual information in the corpus. As discussed above, the constraints or background information provided by context are very useful to link question and answers. Therefore, contexts should be leveraged to detect answers. The linear CRF model can capture the dependency between contiguous sentences. However, it cannot capture the long distance dependency between contexts and answers.

One straightforward method of leveraging context is to detect contexts and answers in two phases, i.e., to first identify contexts, and then label answers using both the context and question information, e.g., the similarity between context and answer can be used as features in CRF's. The two-phase procedure, however, still cannot capture the non-local dependency between contexts and answers in a thread.

To model the long distance dependency between contexts and answers, the invention can use a Skip-chain CRF model to detect context and answer together. Skip-chain CRF model is applied for entity extraction and meeting summarization. The graphical representation of a Skip-chain CRF given in FIG. 2B consists of two types of edges: linear-chain (yₜ to yₜ₋₁) and skip-chain edges (yₜ to yₙ).

TABLE 2
Contingence table (x² = 2 = 963, p-value <0.001)

| Skip-Chain | yᵥ = A | yᵥ ≠ A |
|---|---|---|
| yᵤ = C | 3,504 | 6,822 |
| yᵤ ≠ C | 1,255 | 7,464 |

The skip-chain edges will establish the connection between candidate pairs with high probability of being context and answer of a question. To introduce skip-chain edges between any pairs of non-contiguous sentences can be computationally expensive for Skip-chain CRFs, and also introduce noise. To make the cardinality and number of cliques in the graph manageable, and also eliminate noisy edges, it may be desirable to generate edges only for sentence pairs with high possibility of being context and answer. Given a question Qᵢ in post Pⱼ of a thread with n posts, its contexts usually occur within post Pⱼ or before Pⱼ while answers appear in the posts after Pⱼ. In this paper, we will establish an edge between each candidate answer v and one candidate context in {Pₖ}ₖ₌₁^{j} such that they have the highest possibility of being a context-answer pair of question Qᵢ. We use the product of sim(xᵤ,Qᵢ) and sim(xᵥ{xᵤ,Qᵢ}) to estimate the possibility of being a context-answer pair for (u, v).

$$arg max sim ( {x}_{u} , {Q}_{i} ) \cdot sim ( {x}_{v} , \{ {x}_{u} , {Q}_{i} \} ) \\ u ∈ {\{ {P}_{k} \}}_{k = 1}^{j} \qquad ( 1 )$$

Table 2 shows that yᵤ and yᵥ in the skip chain generated by the heuristics influence each other. The skip-chain CRF model improves the performance of answer detection due to the introduced skip-chain edges that represent the joint probability conditioned on the question, which is exploited by skip-chain feature function: f(yᵤ,yᵥ,Qᵢ,x).

Both Linear CRFs and Skip-chain CRFs label the contexts and answers for each question in separate passes by assuming that questions in a thread are independent. Actually the assumption does not hold in many cases. Let us look at an example. As in FIG. 1, Sentence S10 is an answer for both question 2 and question 3. S10 could be recognized as the answer of question 2 due to the shared word traffic, but there is no direct relation between question 3 and S10. To label S10, we need consider the dependency relation between question 2 and 3. In other words, the question-answer relation between question 3 and S10 can be captured by a joint modeling of the dependency among S10, question 2 and question 3. The labels of the same sentence for two contiguous questions in a thread would be conditioned on the dependency relationship between the questions. Such a dependency cannot be captured by both Linear CRFs and Skip-chain CRFs.

To capture the dependency between the contiguous questions, we employ 2D CRFs to help context and answer detection. In some systems, the 2D CRF model is used to model the neighborhood dependency in blocks within a web page. As shown in FIG. 2C, 2D CRF models the labeling task for all questions in a thread. The ith row in a grid corresponds to one pass of Linear CRF model (or Skip-chain model) which labels contexts and answers for question Qₜ. The vertical edges in the figure represent the joint probability conditioned on the contiguous questions, which will be exploited by 2D feature function: f(yᵢ,ⱼ,yᵢ₊₁,ⱼ,Qᵢ,Qᵢ₊₁,x). Thus, the in-formation generated in single CRF chain could be propagated over the whole grid. In this way, context and answer detection for all questions in the thread could be modeled together.

The Linear, Skip-Chain and 2D CRFs can be generalized as pairwise CRFs, which have two kinds of cliques in graph G: 1) node yₜ and 2) edge (yᵤ, yᵥ) The joint probability is defined as:

$$p ( y \vert x ) = \frac{1}{z ( x )} exp \{ {\sum }_{k , t} {λ}_{k} {f}_{k} ( {y}_{t} , x ) + {\sum }_{k , t} {μ}_{k} {g}_{k} ( {y}_{u} , {y}_{v} , x ) \} ,$$

where Z(x) is the normalization factor, fₖ is the feature on nodes, gₖ is on edges between u and v, and λₖ and μₖ are parameters.

Linear CRFs are based on the first order Markov assumption that the contiguous nodes are dependent. The pairwise edges in Skip-chain CRFs represent the long distance dependency between the skipped nodes, while the ones in 2D CRFs represent the dependency between the horizontal nodes.

For linear CRFs, dynamic programming is used to compute the maximum a posteriori (MAP) of y given x. How-ever, for more complicated graphs with cycles, exact inference needs the junction tree representation of the original graph and the algorithm is exponential to the treewidth. For fast inference, loopy Belief Propagation is implemented.

Given the training Data D={x⁽ⁱ⁾,y⁽ⁱ⁾}ᵢ₌₁ⁿ, the parameter estimation is to determine the parameters based on maximizing the log-likelihood

$${L}_{λ} = {\sum }_{i = 1}^{n} log p ( {y}^{( i )} \vert {x}^{i} ) .$$

In linear CRF model, dynamic programming and L-BFGS can be used to optimize objective function L_{λ}, while for complicated CRFs, Loopy BP are used instead to calculate the marginal probability.

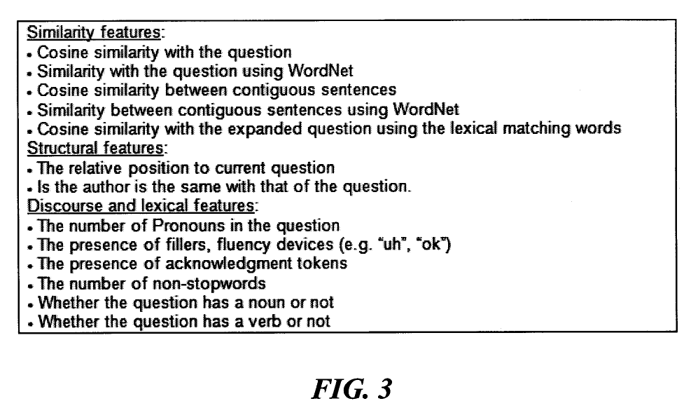

One feature used in linear CRF models for context detection is listed in FIG. 3. The similarity feature is to capture the words similarity and semantic similarity between candidate contexts and answers. The similarity between contiguous sentences will be used to capture the dependency for CRFs. In addition, to bridge the lexical gaps between question and context, one embodiment can use the top-3 context terms for each question term from 300,000 question-description pairs obtained from Yahoo! Answers using mutual information, and then use them to expand question and compute cosine similarity.

The structural features of forums provide strong clues for contexts. For example, contexts of a question usually occur in the post containing the question or preceding posts. The discourse features are extracted from a question, such as the number of pronouns in the question. A more useful feature would be to find the entity in surrounding sentences referred by a pronoun. It was observed that questions often need context if the question do not contain a noun or a verb. In addition, it may be desirable to use similarity features between skip-chain sentences for Skip-chain CRFs and similarity features between questions for 2D CRFs.

For illustrative purpose a sample corpus is disclosed. In this example, the system obtained about 1 million threads from TripAdvisor forum and randomly selected 591 forum threads as our corpus. Each thread in our corpus contains at least two posts and on average each thread consists of 4.46 posts. Two annotators were asked to tag questions, their contexts, and answers in each thread. The kappa statistic for identifying question is 0.96, for linking context and question given a question is 0.75, and for linking answer and question given a question is 0.69. We conducted experiments on both the union and intersection of the two annotated data. The experimental results on both data are qualitatively comparable. We only report results on union data due to space limitation. The union data contains 2,041 questions, 2,479 contexts and 3,441 answers.

TABLE 4
Performance of Question Detection

| Feature | Prec(%) | Rec(%) | F1(%) |
|---|---|---|---|
| 5W-1H words | 69.98 | 14.95 | 24.63 |
| Question Mark | 91.25 | 69.85 | 79.12 |
| RIPPER | 88.84 | 75.81 | 81.76 |
| Our | 88.75 | 87.03 | 87.85 |

For the metrics, we calculated precision, recall, and F1-score for all tasks. All the experimental results are obtained through the average of 5 trials of 5-fold cross validation.

In an example implementation of the question detection method, an experiment was run to evaluate the performance of our question detection method against a method using simple rules. The results are shown in Table 5. The first two rows show the results of simple rules. The rule 5W-1H words is that a sentence is a question if it begins with 5W-1H words; The rule Question Mark is that a sentence is a question if it ends with question mark. Although Question Mark achieves the best precision, its recall is low. Our method outperforms the simple rules in terms of F1-score. Our method differs from other methods in that the present invention adopts SVM model.

TABLE 5
Context and Answer Detection

| | | | |
|---|---|---|---|
| Model | Prec(%) | Rec(%) | F1(%) |

Context Detection

| | | | |
|---|---|---|---|
| SVM | 61.76 | 58.89 | 60.27 |
| C4.5 | 60.09 | 54.13 | 56.95 |
| Linear CRF | 63.25 | 69.17 | 66.07 |

Answer Detection

| | | | |
|---|---|---|---|
| SVM | 61.36 | 46.81 | 53.31 |
| C4.5 | 68.36 | 40.55 | 50.90 |
| Linear CRF | 78.85 | 49.37 | 59.76 |

TABLE 6
Using position information for detection

| | | | |
|---|---|---|---|
| position | Prec(%) | Rec(%) | F1(%) |

Context Detection

| | | | |
|---|---|---|---|
| Previous One | 63.69 | 34.29 | 44.58 |
| Previous All | 43.48 | 76.41 | 55.42 |

Answer Detection

| | | | |
|---|---|---|---|
| Following One | 66.48 | 19.98 | 30.72 |
| Following All | 31.99 | 100 | 48.48 |

Another experiment was run to evaluate Linear CRF model for context and answer detection by comparing with SVM and C4.5. For SVM, we used SVM^{light} and report the best SVM result when using linear or polynomial kernels. For context detection, SVM and C4.5 use the same set of features. For answer detection, for SVM and C4.5 we add the similarity between real context and answer as extra features; otherwise, they failed. As shown in Table 5, Linear CRF model outperforms SVM and C4.5 for both context and answer detection, even if Linear CRF did not use any context information for answer finding. The main reason for the improvement is that CRF models can capture the sequential dependency between segments in forums as discussed in Section 3.2.1.

We next report a baseline of context detection using previous sentences in the same post with its question since contexts often occur in the question post or preceding posts. Similarly, we report a base-line of answer detecting using following segments of a question as answers. The results given in Table 6 show that location information is far from adequate to detect contexts and answers.

We next explain the usefulness of contexts. This experiment is to evaluate the usefulness of contexts in answer detection, by adding the similarity between the context (obtained with different methods) and candidate answer as an extra feature for CRFs. Table 7 shows the impact of context on answer detection using Linear CRFs. L-CRF+context uses the context found by Linear CRFs, and performs better than Linear CRF without context. We also found that the performance of L-CRF+context is close to that using real con-text, while it is better than CRFs using the previous sentence as context. The results indicate that contextual information may improve the performance of answer detection. This was also observed for other classification methods in our experiments: SVM and C4.5 (in Table 5) failed if we did not use context.

TABLE 7
Contextual Information for Answer Detection

| Model | Prec(%) | Rec(%) | F1(%) |
|---|---|---|---|
| No context | 63.92 | 58.74 | 61.22 |
| L-CRF + context | 65.51 | 63.13 | 64.06 |
| Prev. sentence | 61.41 | 62.50 | 61.84 |
| Real context | 63.54 | 66.40 | 64.94 |

This experiment is to evaluate the effectiveness of Skip-Chain CRFs and 2D CRFs for the tasks. The results are given in Table 8. As expected, Skip-chain CRFs outperform LCRF+context since Skip-chain CRFs can model the inter-dependency between contexts and answers while in L-CRF+context the context can only be reflected by the features on the observations. We also observed that 2D CRFs improves the performance of L-CRF+context and we achieved the best performance if we combine the 2D CRFs and Skip-chain CRFs. For context detection, there is slightly improvement, e.g. Precision (64.48%) Recall (71.51%) and F1-score (67.79%).

We also evaluated the contributions of each category of features in FIG. 3 to context detection. We found that similarity features are the most important and structural feature the next. We also observed the same trend for answer detection.

As described above, the present invention provides a new approach to detecting question-context-answer triples in forums.

TABLE 8
Skip-chain and 2D CRFs for answer detection

| Model | Prec(%) | Rec(%) | F1(%) |
|---|---|---|---|
| L-CRF + context | 75.75 | 72.84 | 74.45 |
| Skip-chain | 74.18 | 74.90 | 74.42 |
| 2D | 75.92 | 76.54 | 76.41 |
| 2D + Skip-chain | 76.27 | 78.25 | 77.34 |

It was determined that the disclosed methods often cannot identify questions expressed by imperative sentences in question detection task, e.g. “recommend a restaurant in New York”. This would call for future work. We also observed that factoid questions, one of focuses in the TREC QA community, take less than 10% question in our corpus. It would be interesting to revisit QA techniques to process forum data.

Since contexts of questions are largely unexplored in previous work, we analyze the contexts in our corpus and classify them into three categories: 1) context contains the main content of question while question contains no constraint, e.g. “i will visit NY at Oct, looking for a cheap hotel but convenient Any good suggestion?”; 2) contexts explain or clarify part of the question, such as a definite noun phrase, e.g. ‘We are going on the Taste of Paris. Does anyone know if it is advisable to take a suitcase with us on the tour., where the first sentence is to describe the tour, and 3) con-texts provide constraint or background for question that is syntactically complete, e.g. “We are interested in visiting the Great Wall(and flying from London). Can anyone recommend a tour operator.” In our corpus, about 26% questions do not need context, 12% questions need Type 1 context, 32% need Type 2 context and 30% Type 3.

Referring now to FIG. 4, a block diagram of one embodiment of the present invention is briefly described. The system 100 contains a component for identifying the questions 102 and a component for identifying answers 103. The components 102 and 103 can be combined into one component having any combination of features described above. The storage unit 140 which may include forum data, is communicatively connected to the system 100, which may be a part of the system 100 or a separate unit connected via a network. The output resource 111 can be any one of or a combination of devices, such as a graphical display unit, another computer receiving the data for processing, the storage unit 140, a printer, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A system for discovering questions and answers in a forum stored in a database, the system comprising:
a component for identifying questions from text entries of the database, wherein the questions are identified using a classification method configured to identify questions from forum data as focuses of a thread; and
a component for identifying contexts and answers from text sections of the database, wherein the contexts and answers are identified by the use of conditional random fields, and wherein the component for identifying answers is configured to capture the relationships between contiguous sentences, the component for identifying answers is also configured to produce a list of ranked candidate answers for the identified questions.

2. The system of claim 1 wherein the component for identifying questions also identifies the context of the question, wherein the context of the question is found using the dependency relationships between sentences.

3. The system of claim 1 wherein the conditional random fields employs a linear conditional random field model, wherein the linear conditional random field model is configured to capture the dependency between contiguous sentences.

4. The system of claim 3, wherein the linear conditional random field model is based on the first order Markov assumption that the contiguous nodes are dependent.

5. The system of claim 1 wherein the conditional random fields employs Skip Chain conditional random field model.

6. The system of claim 5, wherein the system is configured to generate edges, wherein the edges are applied to sentence pairs with high possibility of being context and answer.

7. The system of claim 1, wherein the system also employs 2D CRF models for capturing dependency between the contiguous questions.

8. A method for discovering questions and answers, the method comprising:
identifying questions from text entries of the database, wherein the questions are identified using a classification method configured to identify questions from forum data as focuses of a thread; and
identifying contexts and answers from text sections of the database, wherein the contexts and answers are identified by the use of conditional random fields, and wherein the component for identifying answers is configured to capture the relationships between contiguous sentences, the component for identifying answers is also configured to produce a list of ranked candidate answers for the identified questions.

9. The method of claim 8 wherein identifying questions also identifies the context of the question, wherein the context of the question is found using the dependency relationships between sentences.

10. The method of claim 8 wherein the method employs a linear conditional random field model, wherein the linear conditional random field model is configured to capture the dependency between contiguous sentences.

11. The method of claim 10 wherein the linear conditional random field model is based on the first order Markov assumption that the contiguous nodes are dependent.

12. The method of claim 8 wherein the method employs Skip Chain conditional random field model.

13. The method of claim 12 wherein the method is configured to generate edges, wherein the edges are applied to sentence pairs with high possibility of being context and answer.

14. The method of claim 8 wherein the method employs 2D CRF models for capturing dependency between the contiguous questions.

15. A computer-readable storage media comprising computer executable instructions to, upon execution, perform a process for discovering questions and answers, the process including:
identifying questions from text entries of the database, wherein the questions are identified using a classification method configured to identify questions from forum data as focuses of a thread; and
identifying contexts and answers from text sections of the database, wherein the contexts and answers are identified by the use of conditional random fields, and wherein the component for identifying answers is configured to capture the relationships between contiguous sentences, the component for identifying answers is also configured to produce a list of ranked candidate answers for the identified questions.

16. The computer-readable storage media of claim 15, wherein the process of identifying questions also identifies the context of the question, wherein the context of the question is found using the dependency relationships between sentences.

17. The computer-readable storage media of claim 15, wherein the method employs a linear conditional random field model, wherein the linear conditional random field model is configured to capture the dependency between contiguous sentences.

18. The computer-readable storage media of claim 17, wherein the linear conditional random field model is based on the first order Markov assumption that the contiguous nodes are dependent.

19. The computer-readable storage media of claim 15, wherein the process employs Skip Chain conditional random field model.

20. The computer-readable storage media of claim 15, wherein the process is configured to generate edges, wherein the edges are applied to sentence pairs with high possibility of being context and answer.
